(19) United States
(12) Patent Application Publication
(10) Pub. No.: US 2005/0116071 A1
(43) Pub. Date: Jun. 2, 2005

(54) Method of using hot air foam to kill vegetation

(76) Inventor: A. Harry J. Rajamannan, Minneapolis, MN (US)

Correspondence Address: Herman H Bains, 6101 Tracy Avenue, Minneapolis, MN, 55436, US

(21) Appl. No.: 10/723,830

(22) Filed: Nov. 28, 2003

(51) Int. Cl. B05B 3/00

(52) U.S. Cl. 239/722

(57) ABSTRACT

A method of using hot foam to kill vegetation through flexible hoses in railways where the vegetation is growing in a terrain that is not conductive for rigid hot foam nozzles to travel or in other areas where rigid foam nozzles cannot be in close proximity of the vegetation to be killed.

### BACKGROUND OF THE INVENTION AND PRIOR ART

U.S. Pat. No. 5,297,730 was issued to Thompson and Rajamannan for killing weeds using hot water and particularly disclosed spraying hot water and using blanket or apron to serve as a temporary insulation for the ambient temperature.

U.S. Pat. No. 5,433,758 was subsequently issued to Thompson and Rajamannan as an improvement. It discloses using heated water to kill vegetation in combination with the use of a foam blanket, instead of a fixed canopy to insulate the vegetation for a second or more form ambient temperatures.

U.S. Pat. No. 5,215,786 to Kittle uses foam as a form of insulation to protect plant matter in times of frost. Kittle also discloses heating this material to aid its cause. Our invention differs in that the foam will be heated to a degree that will kill the vegetation. We are not trying to protect weeds, but rather kill them.

U.S. Pat. No. 3,713,404 to Lavo et al describes foam to which they add fertilizers, herbicides, fungicides, insecticides, sterilant, grass seed and mixtures thereof. Here they are entraining different materials in the foam and using the foam as a carrier of these specific materials.

U.S. Pat. No. 5,319,878 to Moffet et al describes a method to kill fire ants below the ground with a heated gel forming constituent. He is not using heated gel to kill weeds.

U.S. Pat. No. 3,563,461 to Cole Jr. describes a foam distribution system that is permanently fixed in the ground close to crops to protect them from insects. In addition, this system can be used to feed fertilizer and if necessary, act as an insulator against frost. He does not claim that this system kills unwanted vegetation. Nowhere in this patent has Cole stated that he wanted to kill the trees and plants.

Had Cole raised the temperature of the foam to boiling point, he would have melted the cuticular wax of the leaf and dehydrated the plant to death. His system also differs from our invention in that Cole's in not mobile.

U.S. Pat. No. 3,669,898 to Butler is saving the plant by using foam as in insulation device. He does not wish to kill the plant.

U.S. Pat. No. 5,575,111 to Rajamannan uses hot foam to kill weeds using mobile medium comprising a tractor, trailer, a pick up truck, a self propelled unit or a hand held unit with heated air mixed with heated water.

### DESCRIPTION OF THE PREFERRED EMBODIMENT

The method developed in our previous invention U.S. Pat. No. 5,575,111 is to superheat air, compress it and use into to melt the plant's waxy cuticular coating while utilizing the foam made in the process as a insulating agent. The melting of the waxy layer causes dehydration and death to the plant. The key to this process being effective is producing foam whose temperature is close to the boiling point of water to achieve foam whose temperature is approximately 212° F., the hot air volumetrically could be 80% or 95% and water/surfactant combination could be 5% to 20% off the finished foam. It is this high volume of hot air that will carry the calories needed to melt the waxy cuticle. This mobile apparatus can travel at varying speeds over the weeds or above the ground where weeds that needed to be killed are growing. Applicant's invention is a method to apply simultaneously both hot air and a medium of insulation to the vegetation, in the form of foam, so that the heated vegetation will not cool down rapidly.

The apparatus consists of a mobile unit with a nozzle or nozzles through which foam, consisting of heated water, heated compressed air and a foaming agent such as emulsified oils, surfactants, or polymers, will be sprayed directly on the target weeds to be killed.

When the heated air in the form of foam reaches the target weeds/vegetation, it will stick to the target and give “intimate heat contact” with the vegetation to be killed. It is this contact, with said heated air in the form of hot foam, that kills weeds, vegetation, fungus and insects. The need to keep the foam insulation on target without breaking down can vary from one second to several hours, depending on the type and density of the vegetation.

This process of killing weeds will also simultaneously kill insects, fungus and other undesirable pests harboring within the weeds. In other works, this hot air foam becomes the main killing agent instead of the hot water alone method as provided by our earlier invention.

The improvement to our earlier invention is to use flexible hoses or tubes to deliver the hot foam as close to the vegetation as possible in areas where the main hot foam producing equipment cannot travel or shoot a column of hot foam to the vegetation, to cover the vegetation that are far away from the hot foam producing nozzle such that even if the hot foam cools off below the effective killing temperature range but with the addition of cuticle wax tearing agents such as Citric Acid, Propionic Acid, Acetic Acid, Linoleic Acid, Oleic Acid, Stearic Acid, Palmitic Acid, Lauric Acid, Myrisitic Acid, Capric Acid, Caprylic Acid, Caproic Acid will kill vegetation such as weeds at lower temperatures than the previously invented hot foam allowing a more efficient operation.

### SUMMARY OF THE INVENTION

An object of the invention is to use mobile or static hot foam producing equipment as in our earlier U.S. Pat. No. 5,575,111 but use flexible insulated tubing to reach vegetation growing in slopes or terrain not conducive to the mobile equipment to travel and to add cuticle melting additives to the hot foam so that the killing of the vegetation will take place at temperatures below the current killing range to 130° F. to 212° F. Thus using less water or hot foam allowing a more efficient use of water and energy.

### BRIEF DESCRIPTIONS OF THE DRAWINGS

FIG. 1 is a diagrammatic view of the apparatus to be used in railways or irregular terrain.

FIG. 2 is a diagrammatic view of the method of shooting a column of hot foam to vegetations to kill these vegetations.

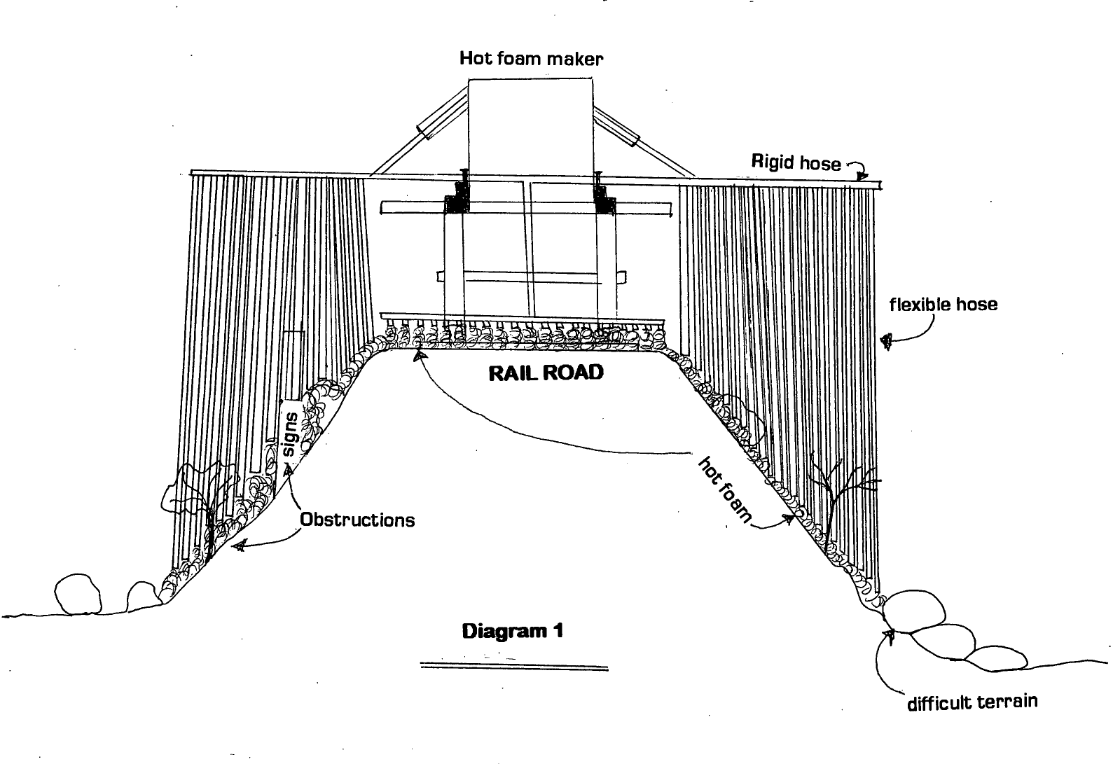

In FIG. 1 of the drawing, it will be seen that in typical railways the rails are in a elevated table with slopes on both sides of the railroad. This means that it is easy to cover only the actual railroad width to control weeds growing within the rails and a meter or so on either side.

The slopes may have rocks, stones, and railway equipment, guard rails, etc. That will prevent a slope-hugging boom with hot foam nozzles to be used, as the boom will break on contact with the above-mentioned obstructions.

So we have invented a series of flexible tubing emanating from these side booms and these flexible tubes are insulated to prevent, undue cooling, and these tubes become extensions of the boom nozzles or have nozzles attached to the end of these tubes.

The boom extending on both sides of the mobile hot foam producing unit can be folded back or up or front but in normal operating conditions will stretch out either perpendicularly or at slight slopes to reflect the angle of the slopes, but never be close to the ground or vegetation or obstructions.

The insulated flexible tubes however will hang from the boom and will touch the vegetation or soil or the obstructions on the slopes without breaking off The hot foam producer can now produce the foam, and push it though the insulated tubing in the boom and distribute it to the “hanging tubes” evenly so that the tubes will cover the vegetation with this hot foam.

At this point the hot foam mobile equipment, can move along on the railroad leaving a trail of hot foam on the vegetation on the flat railroad and also on the slopes adjoining the railroad.

Adding a cuticle waxy tearing agent will also allow temperature drops of the hot foam, as this additive will augment the killing effects of the hot foam.

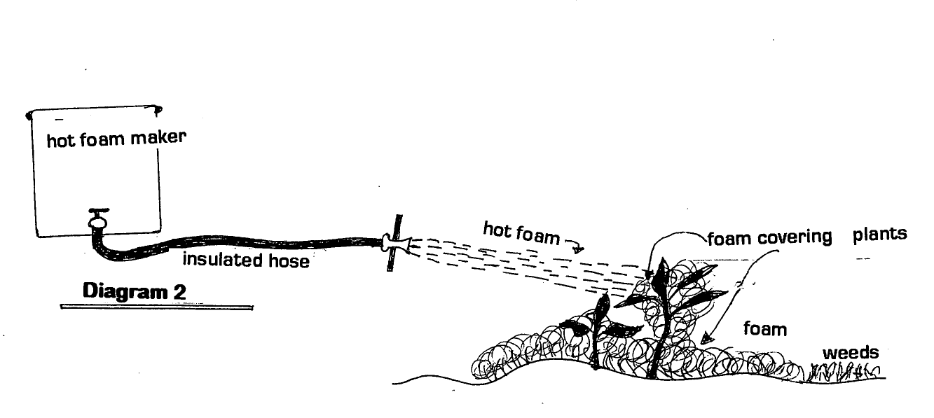

Similarly the addition of waxy cuticle wrecking agents to the hot foam will allow a hot foam column thrower such as shown in FIG. 2 to allow the hot foam to cool a little but still be sufficiently hot enough to kill the vegetation.

1. A method of using flexible hoses as an extension of rigid nozzles to allow hot foam to be applied on vegetation growing in difficult terrain such as slopes or areas where obstructions such as rocks and signs are present, which prevents rigid nozzles to be used, and the flexible hoses spewing hot foam will not be damaged, to kill or defoliate unwanted vegetation and weeds and for killing or inhibiting the establishment of fungus, bacteria, virus and insects.

2. The method as defined in claim 1, where in acids such as Citric Acid;
Propionic Acid, Acetic acid, Linoleic Acid, Oleic Acid, Stearic Acid, Palmitic Acid, Llauric Acid, Myristic Acid, Capric Acid, Caprylic Acid, Caproic Acid are added to extend the performance of the hot foam.

3. The method as defined in claim 2, where the hot foam performs defoliation and inhibiting the establishment of Fungii and bacteria at temperatures between 212 degrees Fahrenheit and 100 degrees Fahrenheit.
